(19) United States
(12) Patent Application Publication
(10) Pub. No.: US 2010/0172208 A1
(43) Pub. Date: Jul. 8, 2010

(54) SYSTEM AND TECHNIQUE FOR LOCAL IN-SEA PROCESSING OF PARTICLE MOTION DATA

(76) Inventors: Ashok Belani, Los Altos Hills, CA (US); Kemal Ozdemir, Asker (NO); Vidar Husom, Asker (NO); Hans Paulson, Versailles (FR); Nicolas Goujon, Oslo (NO)

Correspondence Address: WesternGeco L.L.C.;Kevin McEnaney, IP Dept, 10001 Richmond Avenue, HOUSTON, TX, 77042-4299, US

(21) Appl. No.: 12/349,763

(22) Filed: Jan. 7, 2009

(51) Int. Cl. G01V 1/38; G01V 1/36

(52) U.S. Cl. 367/21; 367/24

(57) ABSTRACT

A system includes a seismic streamer, which includes particle motion sensors and processors. Each processor is associated with a different one of the particle motion sensors and is adapted to process data acquired by the associated particle motion sensor to compensate the data for a characteristic of the sensor.

### BACKGROUND

The invention generally relates to a system and technique for local in-sea processing of particle motion data.

Seismic exploration involves surveying subterranean geological formations for hydrocarbon deposits. A survey typically involves deploying seismic source(s) and seismic sensors at predetermined locations. The sources generate seismic waves, which propagate into the geological formations creating pressure changes and vibrations along their way. Changes in elastic properties of the geological formation scatter the seismic waves, changing their direction of propagation and other properties. Part of the energy emitted by the sources reaches the seismic sensors. Some seismic sensors are sensitive to pressure changes (hydrophones), others to particle motion (e.g., geophones), and industrial surveys may deploy only one type of sensors or both. In response to the detected seismic events, the sensors generate electrical signals to produce seismic data. Analysis of the seismic data can then indicate the presence or absence of probable locations of hydrocarbon deposits.

Some surveys are known as “marine” surveys because they are conducted in marine environments. However, “marine” surveys may be conducted not only in saltwater environments, but also in fresh and brackish waters. In one type of marine survey, called a “towed-array” survey, an array of seismic sensor-containing streamers and sources is towed behind a survey vessel.

### SUMMARY

In an embodiment of the invention, a technique includes providing a seismic streamer that includes particle motion sensors. For each of the particle motion sensors, data acquired by the particle motion sensor are processed locally near the particle motion sensor to compensate the data for a characteristic of the sensor. The data acquired by the particle motion sensor may be further processed for such purposes as noise attenuation and deghosting.

In another embodiment of the invention, a system includes a seismic streamer, which includes particle motion sensors and processors. Each processor is associated with a different one of the particle motion sensors and is adapted to process data acquired by the associated particle motion sensor to compensate the data for a characteristic of the sensor. The data acquired by the particle motion sensor may be further processed for such purposes as noise attenuation and deghosting.

Advantages and other features of the invention will become apparent from the following drawing, description and claims.

### BRIEF DESCRIPTION OF THE DRAWING

FIG. 1 is a schematic diagram of a marine seismic data acquisition system according to an embodiment of the invention.

FIG. 2 is a flow diagram depicting a technique to process data acquired by particle motion sensors according to an embodiment of the invention.

FIG. 3 is schematic diagram of a sensor unit of the streamer of FIG. 1 according to an embodiment of the invention.

FIG. 4 is a flow diagram depicting a technique to preprocess data acquired by a particle motion sensor prior to processing the data for noise attenuation and/or deghosting.

FIG. 5 is a schematic diagram of a data processing system according to an embodiment of the invention.

### DETAILED DESCRIPTION

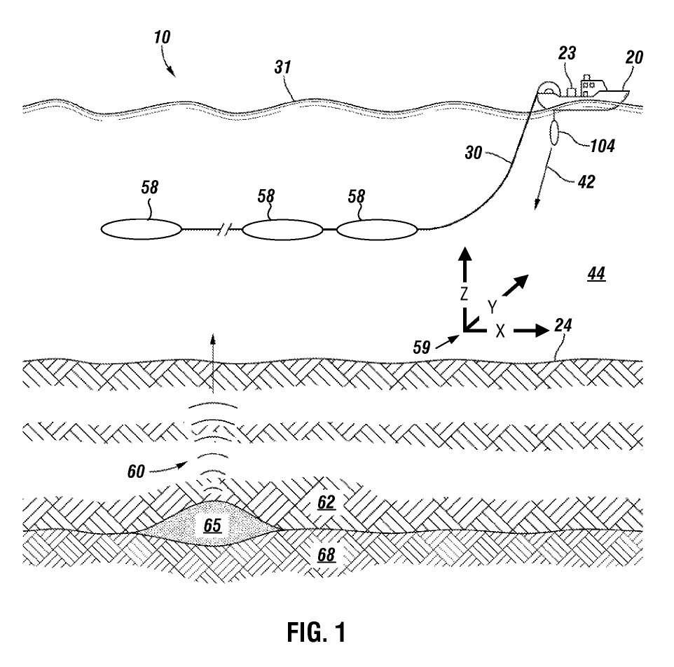

FIG. 1 depicts an embodiment 10 of a marine seismic data acquisition system in accordance with some embodiments of the invention. In the system 10, a survey vessel 20 tows one or more seismic streamers 30 (one streamer 30 being depicted in FIG. 1) behind the vessel 20. The seismic streamers 30 may be several thousand meters long and may contain various support cables (not shown), as well as wiring and/or circuitry (not shown) that may be used to support communication along the streamers 30. In general, each streamer 30 includes a primary cable into which is mounted seismic sensor units 58 that record seismic signals, and each streamer 30 is connected to the survey vessel 20 through a lead-in cable (not shown in FIG. 1).

In accordance with some embodiments of the invention, the seismic sensor unit 58 may contain multi-component seismic sensors, each of which is capable of detecting a pressure wavefield and at least one component of a particle motion that is associated with acoustic signals that are proximate to the multi-component seismic sensor. Examples of particle motions include one or more components of a particle displacement, one or more components (inline (x), crossline (y) and vertical (z) components (see axes 59, for example)) of a particle velocity and one or more components of a particle acceleration.

Depending on the particular embodiment of the invention, the seismic sensor unit 58 may include one or more hydrophones, geophones, particle displacement sensors, particle velocity sensors, accelerometers, pressure gradient sensors, or combinations thereof.

For example, in accordance with some embodiments of the invention, a seismic sensor unit 58 may include a hydrophone for measuring pressure and three orthogonally-aligned accelerometers to measure three corresponding orthogonal components of particle velocity and/or acceleration near the unit 58. It is noted that a multi-component seismic sensor may be implemented as a single device (as depicted in FIG. 1) or may be implemented as a plurality of devices, depending on the particular embodiment of the invention. A particular multi-component seismic sensor may also include pressure gradient sensors, which constitute another type of particle motion sensors. Each pressure gradient sensor measures the change in the pressure wavefield at a particular point with respect to a particular direction. For example, one of the pressure gradient sensors may acquire seismic data indicative of, at a particular point, the partial derivative of the pressure wavefield with respect to the crossline direction, and another one of the pressure gradient sensors may acquire, a particular point, seismic data indicative of the pressure data with respect to the inline direction.

The marine seismic data acquisition system 10 includes at least one seismic source 104 that may be formed from one or more seismic source elements, such as air guns, for example. As the seismic streamers 30 are towed behind the survey vessel 20, acoustic signals 42 (an exemplary acoustic signal 42 being depicted in FIG. 1), often referred to as “shots,” are produced by the seismic source(s) 104 and are directed down through a water column 44 into strata 62 and 68 beneath a water bottom surface 24. The acoustic signals 42 are reflected from the various subterranean geological formations, such as an exemplary formation 65 that is depicted in FIG. 1.

The incident acoustic signals 42 produce corresponding reflected acoustic signals, or pressure waves 60, which are sensed by the sensors of the seismic sensor units 58. It is noted that the pressure waves that are received and sensed by the seismic sensor units 58 include “up going” pressure waves that propagate to the units 58 without reflection, as well as “down going” pressure waves that are produced by reflections of the pressure waves 60 from an air-water boundary 31.

The sensors of the seismic sensor units 58 generate signals (digital signals, for example), called “traces,” which indicate the acquired measurements of the pressure wavefield and particle motion. The traces may be recorded and at least partially processed by a computer 23 (herein called the “onboard computer 23”) that is deployed on the survey vessel 20, in accordance with some embodiments of the invention. For example, a particular multi-component seismic sensor may provide a trace, which corresponds to a measure of a pressure wavefield by its hydrophone; and the multicomponent sensor may provide one or more traces that correspond to one or more components of particle motion, which are measured by its accelerometers.

The goal of the seismic acquisition is to build up an image of a survey area for purposes of identifying subterranean geological formations, such as the exemplary geological formation 65. Subsequent analysis of the representation may reveal probable locations of hydrocarbon deposits in subterranean geological formations.

In accordance with embodiments of the invention, the seismic sensor units 58 process the acquired seismic data before the data are communicated to the vessel 20, thereby offloading some of the processing that has traditionally been performed by the onboard computer 23 or by an offsite processing facility.

By performing at least some of the processing on the streamer 30, the processing load onboard the vessel 20 may be significantly reduced; the bandwidth requirements for data transmissions between the streamer 30 and the vessel 20 may be significantly reduced; and the power that is otherwise consumed in transmitting the raw seismic data to the vessel 20 may be significantly reduced.

The type of processing performed by the sensor units 58 may take on numerous forms, depending on the particular embodiment of the invention. As examples, as described in more detail below, the seismic sensor units 58 may perform one of more of the following: 1.) preprocessing operations; 2.) noise attenuation; and 3.) deghosting.

The sensor units 58, in accordance with some embodiments of the invention, apply the preprocessing operations before any noise attenuation operations and apply the noise attenuation operations before any deghosting operations. In general, the preprocessing operations may include operations for perturbation correction, instrument response matching and/or coordinate system conversion.

The preprocessing operations may include perturbation corrections for purposes of compensating the acquired particle motion data for specific individual characteristics of the particle motion sensors. With these corrections, the complexity of a subsequently applied noise attenuation filter may be reduced considerably. As examples, the perturbation corrections may involve compensating for sensitivity differences between particle motion sensors, compensating for misalignment between the sensor axes and the inline axis of the streamer 30, and instrument response variations from sensor to sensor. As examples, the instrument response variations may include such variations as variations in amplitude, phase and/or frequency. There are many different ways of estimating the required correction parameters to apply in the perturbation corrections, such as the ways described in U.S. patent application Ser. No. 11/740,680, entitled “SYSTEM AND TECHNIQUE TO REMOVE PERTURBATION NOISE FROM SEISMIC SENSOR DATA,” filed on Apr. 26, 2007, (Attorney Docket No. 14.0336) and U.S. patent application Ser. No. 12/193,040, entitled “ESTIMATING AND CORRECTING PERTURBATIONS ON SEISMIC PARTICLE MOTION SENSORS EMPLOYING SEISMIC SOURCE SIGNALS,” filed on Aug. 17, 2008, (Attorney Docket No. 14.0420), which are each hereby incorporated by reference.

The correction parameters may be estimated prior to the current survey and may be stored in a memory onboard the vessel 20 and/or in a memory onboard the sensor units 58, depending on the particular embodiment of the invention.

Another preprocessing operation that may be performed for each sensor unit 58 before noise removal is an operation to estimate the orientation of the unit's sensors, so that the sensor coordinates may be transformed from a local streamer coordinate space to a global coordinate space. For example, the local-to-global coordinate transformation ensures that the z component actually refers to the vertical component in the global coordinate space. It is noted that if the data are not “rotated” to the global coordinate space prior to noise removal, there may be significant signal losses.

In accordance with some embodiments of the invention, the estimation of the sensor orientations may be performed on board the vessel 20 (as a non-limiting example), and for these embodiments of the invention, the corresponding correction parameters may be communicated from the vessel 20 to the streamer 30 so that the correction parameters may be stored locally in the sensor units 58. In other embodiments of the invention, the sensor units 58 may perform all or part of the determination of the correction parameters to apply in the coordinate transformations. Thus, many variations are contemplated and are within the scope of the appended claims.

An additional benefit of having in-sea processing capability for the particle motion data is that deghosting may be performed in-sea. As an example, in accordance with some embodiments of the invention, a deghosting algorithm that uses a finite impulse response (FIR) filter may be used for each frequency. An example of such a deghosting filter is described in U.S. Pat. No. 7,368,397 (Attorney Docket No. 57.0574-US), which was issued on Jun. 10, 2008 and is hereby incorporated by reference in its entirety. The coefficients of the corresponding deghosting filters may be stored locally in each sensor unit 58, in accordance with some embodiments of the invention. Due to the FIR filter arrangement, the filter weights may be combined with the weights used in the noise attenuation algorithm (such as the algorithm described in U.S. Pat. No. 7,426,439, (Attorney Docket No. 14.0309) entitled “METHOD AND APPARATUS FOR MARINE SEISMIC DATA ACQUISITION” which issued on Sep. 16, 2008, such that the sensor unit 58 provides an output that may be readily summed in-sea for purposes of producing deghosted output data, which then may be subsequently communicated from the streamer 30 to the vessel 20.

The noise attenuation operations typically enhance the results of the deghosting operations, and thus, for embodiments of the invention in which the seismic sensor units 58 perform deghosting, units 58 may first perform in-sea noise attenuation. As an example, the sensor units 58 may process the seismic data to attenuate noise, as described in U.S. patent application Ser. No. 11/740,641, entitled, “METHOD FOR OPTIMAL WAVE FIELD SEPARATION,” which was filed on Apr. 26, 2007 (Attorney Docket No. 14.0327), which is hereby incorporated by reference in its entirety. Hence, in order to enhance the deghosting at the frequency band of interest, the noise may be attenuated locally at the sensor units 58 on the streamer 30 prior to the deghosting, which may be performed on or off of the streamer 30.

Marine seismic acquisition typically is subject to many different sources of noise and sensor perturbations, which degrade the fidelity of the acquired pressure signal and reduce the efficiency of the seismic acquisition. As examples, the sources of noise may include swell noise, vibration noise, bulge waves (in wave platforms), turbulence and/or cross-flow noise.

The particle motion sensors may pick up relatively strong vibration noise, especially at lower frequencies. The vibration noise and the seismic signal have different apparent velocities of propagation. By locally processing the data acquired by relatively densely-spaced particle motion sensors on the streamer 30, the noise levels may be reduced significantly such that the particle motion sensors may become even “quieter” than pressure sensors at the frequency band of interest, as described in U.S. Pat. No. 7,426,439, (Attorney Docket No. 14.0309) entitled “METHOD AND APPARATUS FOR MARINE SEISMIC DATA ACQUISITION” which issued on 16/SEP/2008, and which is hereby incorporated by reference in its entirety. Any additional noise present in the particle motion data (data remaining at the lower frequencies, for example) may be processed by a suitable algorithm, such as the algorithm set forth in the 14.0327 patent application.

In accordance with some embodiments of the invention, the particle motion sensors may be spaced closer together than the pressure sensors along the streamer 30, and in general, the particle motion sensors may be more densely spaced apart along the streamer 30 than required spacing to avoid aliasing of the signal. By performing noise attenuation at sea on the streamer 30, the processed particle motion data that is sent to the vessel 20 may be therefore reduced to only include the particle motion data for every hydrophone position. Therefore, a benefit to local noise processing on the streamer 30 is that the bandwidth requirements for data transmissions between the streamer 30 and the vessel 20 may be relaxed.

It is noted that in accordance with some embodiments of the invention, the above-mentioned preprocessing may be performed on the streamer 30, and the noise attenuation may be performed on-board the vessel 20 by the on-board computer 23. However, in accordance other embodiments of the invention, both the preprocessing and the noise attenuation may be performed in-sea on the streamer 30 by the sensor units 58. Furthermore, in accordance with some embodiments of the invention, the preprocessing, noise attenuation and deghosting may be performed in-sea on the streamer 30 by the sensor units 58.

Performing some or all of the preprocessing, noise attenuation and/or deghosting locally at the sensor locations greatly simplifies the bandwidth requirements for communications along the streamer 30 and between the streamer 30 and the vessel 20. For example, by performing some or all of the noise processing locally at the sensor unit 58, the bandwidth requirements are relaxed, because only the required data (for instance, only the z or z and y components depending on the application) are provided as outputs from the sensor units 58. By distributing the computational tasks to the individual sensor nodes, the hardware needed to perform the noise attenuation may be greatly simplified. For example, by employing the algorithm set forth in Attorney Docket No. 14.0309, the sensor unit outputs may be summed at periodic intervals on the streamer 30 (for example, at every hydrophone position), and then only these summed signals are communicated to the vessel 20 for further on-board processing. By performing perturbation correction and rotation of the sensor coordinates to the global coordinates of the sensor unit locally at the sensor locations, the inline (or x) components are not communicated to the vessel 20, because the inline components may be estimated from the hydrophone data. To be more conservative, only the inline component at every hydrophone position may be communicated to the vessel 20, in some embodiments of the invention, because the nature of the inline vibration noise allows the sampling of the inline component to be much sparser than the sampling of the crossline and vertical components.

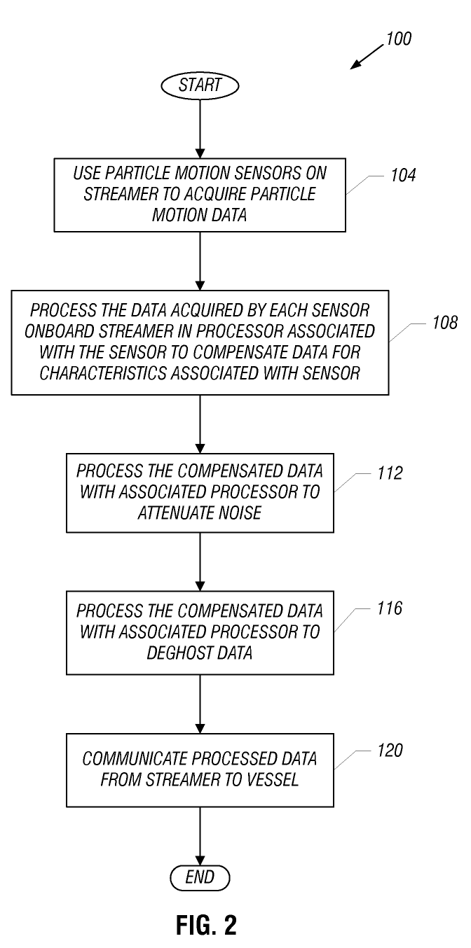

Referring to FIG. 2, in accordance with some embodiments of the invention, particle motion data may be acquired and processed according to an exemplary technique 100. Pursuant to the technique 100, particle motion sensors on a streamer 30 are used (block 104) to acquire particle motion data. The particle motion data acquired by each sensor are processed (block 108) on board the streamer 30 in a processor that is associated with the sensor to compensate the data for characteristics, which are associated with the sensor, such as a sensor sensitivity, an equipment response, a sensor alignment, etc. The compensated data may then be processed (block 112) with the associated processor to attenuate noise in the data. As noted above, this noise attenuation may be alternatively performed on board the vessel 20, in accordance with other embodiments of the invention.

In addition to processing the noise on the streamer 30, the compensated data may be processed to deghost the data, pursuant to block 116. However, as noted above, in accordance with other embodiments of the invention, the deghosting may be performed on board the vessel 20 or at another facility. Thus, many variations and embodiments of the invention are contemplated and are within the scope of the appended claims.

The data that is processed on board the streamer 30 are communicated (block 120) from the streamer 30 to the vessel 20. Thus, the amount of data that is communicated from the streamer to the vessel 20 depends on the degree of in-sea, or local, processing that is performed on the streamer 30.

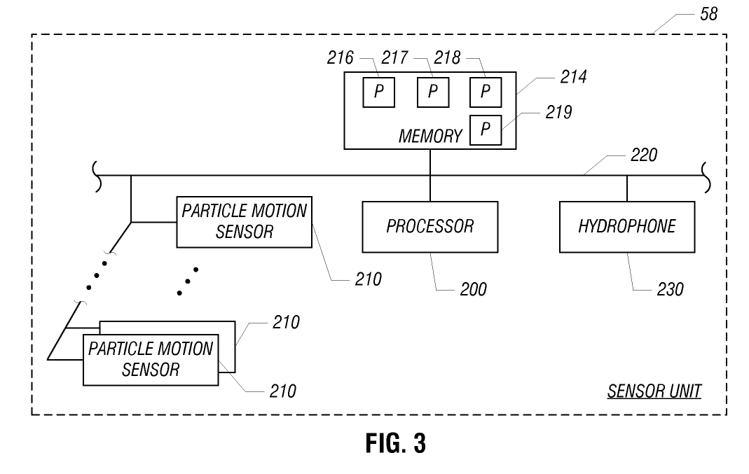

As a more specific example, FIG. 3 depicts an exemplary block diagram of the sensor unit 58 in accordance with some embodiments of the invention. In general, the sensor unit 58 includes a processor 200, such as a digital signal processing (DSP) unit, an application specific integrated circuit (ASIC), a microprocessor, a microcontroller, etc., depending on the particular embodiment of the invention. The processor 200 processes the particle motion data that are acquired by the particle motion sensors 210 of the sensor unit 58, in accordance with some embodiments of the invention.

In this regard, in accordance with some embodiments of the invention, the processor 200, particle motion sensors 210 and a hydrophone 230 of the sensor unit 58 may communicate over a local bus 220 that is coupled to a larger streamer-based network, which links the sensor units 58 of the streamer 30 together. In this regard, the sensor units 58 may be nodes of the larger network.

In accordance with some embodiments of the invention, the processor 200 may process data 219 indicative of particle motion measurements, which are stored in a memory 214. This processing may include the above-described preprocessing, noise attenuation, deghosting, etc. It is noted that the memory 214 may be integrated with or separate from the processor 200 (as depicted in FIG. 3), depending on the particular embodiment of the invention. Additionally, the memory 214 may store various program instructions, which are executed by the processor 200 for purposes of processing the acquired particle motion data. As examples, the program instructions may include program instructions 216 for preprocessing the particle motion data; program instructions 217 for attenuating noise associated with the data; and program instructions 218 for deghosting particle motion data.

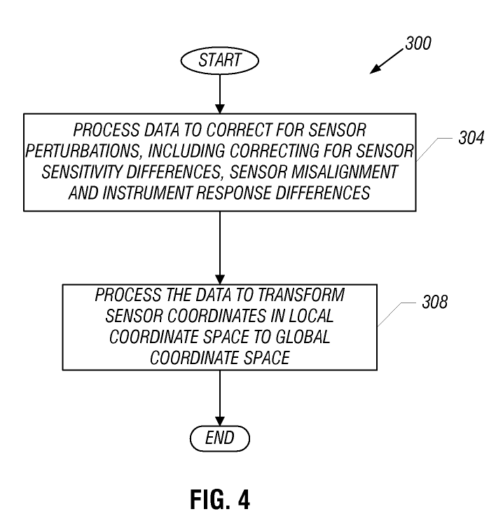

Referring to FIG. 4, in accordance with some embodiments of the invention, the sensor unit 58 may perform a technique 300 that is depicted in FIG. 4 for purposes of preprocessing the data before noise attenuation and deghosting. Pursuant to the technique 300, the sensor unit 58 processes (block 304) the data to correct for sensor perturbations, including correcting for sensor sensitivity differences, sensor misalignment differences and instrument response differences. The technique 300 also includes processing (block 308) the data to transform the sensor coordinates from a local coordinate space to a global coordinate space.

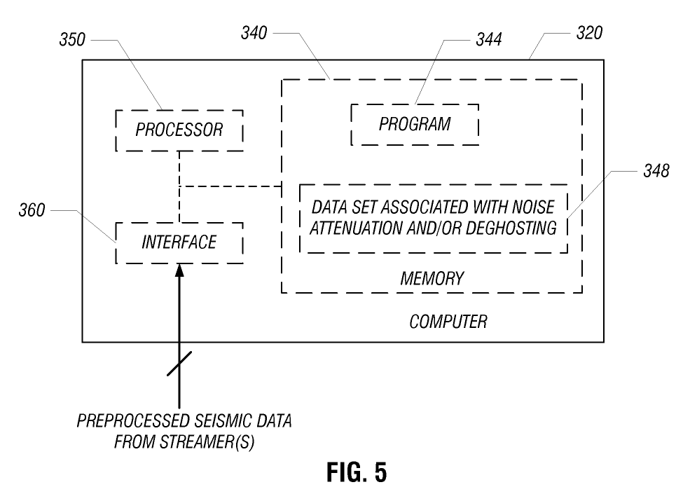

Referring to FIG. 5, in accordance with some embodiments of the invention, a data processing system 320 may perform at least part of the techniques that are disclosed herein, such as, for example, deghosting processing that is performed on board the vessel 20 or later at a land-based facility. Thus, the system 320 may be located on the survey vessel 20, at a remote land-based facility, etc. In accordance with some embodiments of the invention, the system 320 may include a processor 350, such as one or more microprocessors and/or microcontrollers.

The processor 350 may be coupled to a communication interface 360 for purposes of receiving data indicative of seismic measurements, model parameters, geophysical parameters, survey parameters, etc. The data pertaining to the seismic measurements may be pressure data, multi-component data, etc.

As a non-limiting example, the interface 360 may be a USB serial bus interface, a network interface, a removable media (such as a flash card, CD-ROM, etc.) interface or a magnetic storage interface (IDE or SCSI interfaces, as examples). Thus, the interface 360 may take on numerous forms, depending on the particular embodiment of the invention.

In accordance with some embodiments of the invention, the interface 360 may be coupled to a memory 340 of the system 320 and may store, for example, various input and/or output data sets involved with the preprocessing, noise attenuation and deghosting techniques that are described herein. The memory 340 may store program instructions 344, which when executed by the processor 350, may cause the processor 350 to perform at least some of the deghosting, noise attenuation and/or preprocessing techniques that are described herein and display results obtained via the technique(s) on a display (not shown in FIG. 5) of the system 320, in accordance with some embodiments of the invention.

While the present invention has been described with respect to a limited number of embodiments, those skilled in the art, having the benefit of this disclosure, will appreciate numerous modifications and variations therefrom. It is intended that the appended claims cover all such modifications and variations as fall within the true spirit and scope of this present invention.

What is claimed is:

1. A method comprising:
providing a seismic streamer comprising particle motion sensors; and
for each of the particle motion sensors, processing data acquired by the particle motion sensor locally near the particle motion sensor to compensate the data for a characteristic of the sensor.

2. The method of claim 1, wherein the processing the data comprises:
processing the data to compensate the data for an alignment of the sensor relative to an axis of the streamer.

3. The method of claim 1, wherein the processing the data comprises:
processing the data to transform coordinates of the sensor from a local coordinate space to a global coordinate space.

4. The method of claim 1, wherein the processing the data comprises:
processing the data to compensate the data for a sensitivity of the sensor relative to sensitivities of the other sensors.

5. The method of claim 1, wherein the processing the data comprises:
processing the data to compensate the data for an instrument response of the sensor relative to instrument responses of the other sensors.

6. The method of claim 1, wherein the processing the data comprises:
providing processors on the streamer, each processor being associated with one of the particle motion sensors;
for each particle motion sensor, processing the data in the associated processor.

7. The method of claim 1, further comprising:
for each of the particle motion sensors, processing the data to attenuate noise.

8. The method of claim 7, wherein the processing the data to attenuate noise produces compensated data, further comprising:
communicating the compensated data from the streamer to a vessel.

9. The method of claim 1, further comprising:
for each of the particle motion sensors, processing the data to deghost the data.

10. The method of claim 9, wherein the processing the data to deghost the data produces compensated data, further comprising:
communicating the compensated data from the streamer to a vessel.

11. The method of claim 1, wherein the processing produces compensated data, further comprising:
communicating the compensated data from the streamer to a vessel.

12. A system comprising:
a seismic streamer comprising particle motion sensors and processors,
wherein each processor is associated with a different one of the particle motion sensors and is adapted to process data acquired by the associated particle motion sensor to compensate the data for a characteristic of the sensor.

13. The system of claim 12, further comprising:
a survey vessel to tow the streamer.

14. The system of claim 12, wherein each processor is adapted to process the data acquired by the associated particle motion sensor to compensate the data for an alignment of the sensor relative to an axis of the streamer.

15. The system of claim 12, wherein each processor is adapted to process the data acquired by the associated particle motion sensor to transform coordinates of the sensor from a local coordinate space to a global coordinate space.

16. The system of claim 12, wherein each processor is adapted to process the data acquired by the associated particle motion sensor to compensate the data for a sensitivity of the sensor relative to sensitivities of the other sensors.

17. The system of claim 12, wherein each processor is adapted to process the data acquired by the associated particle motion sensor to compensate the data for an instrument response of the sensor relative to instrument responses of the other sensors.

18. The system of claim 12, wherein each processor is adapted to further process the data acquired by the associated particle motion sensor to attenuate noise.

19. The system of claim 12, wherein the each processor is adapted to process the data acquired by the associated particle motion sensor from the streamer to a vessel.

20. The system of claim 12, wherein each processor is adapted to further process the data acquired by the associated particle motion sensor to deghost the data.
